(19) United States
(12) Patent Application Publication
(10) Pub. No.: US 2006/0103894 A1
(43) Pub. Date: May 18, 2006

(54) Portable imaging system

(76) Inventor: Modest Khovaylo, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/992,059

(22) Filed: Nov. 18, 2004

(51) Int. Cl. H04N 1/04

(52) U.S. Cl. 358/474

(57) ABSTRACT

A portable imaging system comprises a portfolio having at least two panels foldably coupled to each other where at least one of the at least two panels is adapted for releasable engagement of a media object thereto. The system also comprises an imaging device coupled to another of the at least two panels where the at least one panel is configured to automatically align the media object with the imaging device when the at least one panel is disposed in a position facing the another panel to facilitate scanning of the media object by the imaging device.

### BACKGROUND OF THE INVENTION

Imaging systems are becoming increasingly popular. For example, imaging systems enable document scanning of newspaper clippings, presentation handouts, and/or a variety of other types of media objects. However, portability of the imaging system remains an important design concern. For example, such imaging systems generally contain a platen for supporting a media object during scanning of the media object. The platen, as well as other components of the imaging system, generally remain susceptible to damage caused by the portable nature and use of the imaging system.

### SUMMARY OF THE INVENTION

In accordance with one embodiment of the present invention, a portable imaging system comprises a portfolio having at least two panels foldably coupled to each other where at least one of the at least two panels is adapted for releasable engagement of a media object thereto. The imaging system also comprises an imaging device coupled to another of the at least two panels where the at least one panel is configured to automatically align the media object with the imaging device when the at least one panel is disposed in a position facing the another panel to facilitate scanning of the media object by the imaging device.

In accordance with one embodiment of the present invention, a portable imaging system comprises a portfolio having a first panel movably coupled to a second panel and an imaging device coupled to the second panel. The first panel is adapted to automatically position a media object disposed thereon within a scanning area of the imaging device when the first panel is disposed in a position facing the second panel to facilitate scanning of the media object by the imaging device.

In accordance with yet another embodiment of the present invention, a portable imaging system comprises a portfolio having a first panel movably coupled to a second panel and where the second panel has an imaging device coupled thereto. The first panel is adapted to receive an image written thereto by a user and is adapted to automatically align the written image with the imaging device when the first panel is disposed in a position facing the second panel to facilitate scanning of the written image by the imaging device.

### BRIEF DESCRIPTION OF THE DRAWINGS

For a more complete understanding of the present invention and the advantages thereof, reference is now made to the following descriptions taken in connection with the accompanying drawings in which:

FIG. 1 is a diagram illustrating an embodiment of a portable imaging system in accordance with the present invention;

FIG. 2 is a diagram illustrating the embodiment of the portable imaging system illustrated in FIG. 1 having a media object coupled thereto;

FIG. 3 is a diagram illustrating another embodiment of a portable imaging system in accordance with the present invention;

FIG. 4 is a diagram illustrating another embodiment of a portable imaging system in accordance with the present invention; and

FIG. 5 is a diagram illustrating another embodiment of a portable imaging system in accordance with the present invention.

### DETAILED DESCRIPTION OF THE DRAWINGS

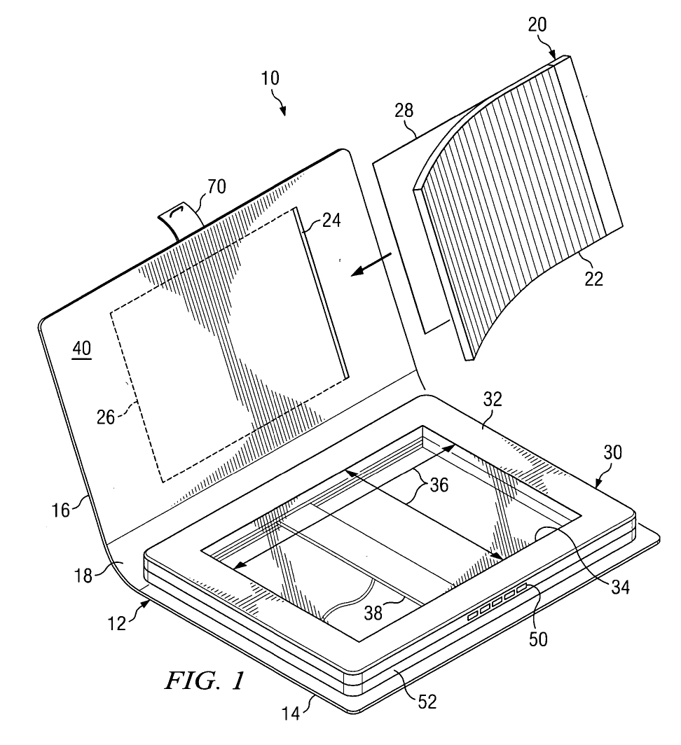

The preferred embodiments of the present invention and the advantages thereof are best understood by referring to FIGS. 1-5 of the drawings, like numerals being used for like and corresponding parts of the various drawings.

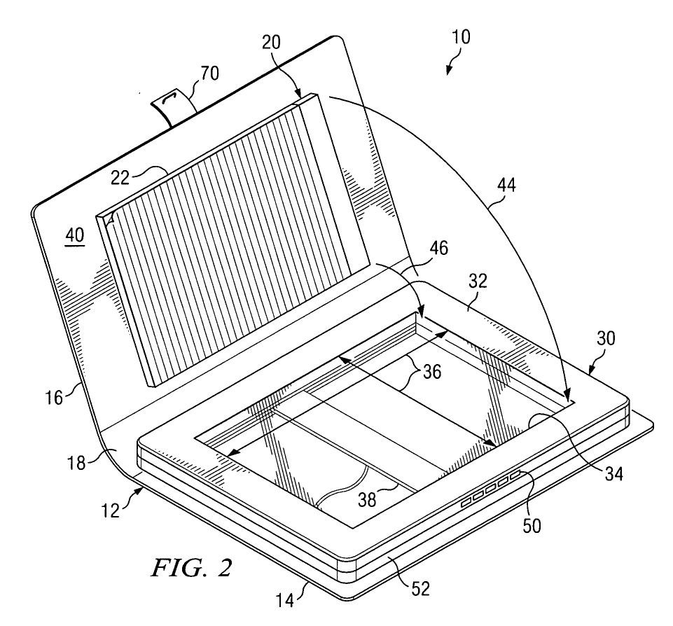

FIGS. 1 and 2 are diagrams illustrating an embodiment of a portable imaging system 10 in accordance with the present invention. In the embodiment illustrated in FIGS. 1 and 2, system 10 comprises a portable portfolio 12 having panels 14 and 16. In FIGS. 1 and 2, portfolio 12 is illustrated in an open position. Panels 14 and 16 are flexibly and/or movably coupled relative to each other to facilitate positioning of panels 14 and 16 toward and/or facing each other. For example, in the embodiment illustrated in FIGS. 1 and 2, panels 14 and 16 are rotatably and integrally coupled to each other via a flexible binder portion 18. However, it should be understood that panels 14 and 16 may be otherwise movably coupled to each other (e.g., via rings such as found in a three-ring binder). Additionally, it should be understood that panels 14 and 16 may be coupled together directly (e.g., via binder portion 18) or indirectly (e.g., via another intervening and/or intermediate panel). In the embodiment illustrated in FIGS. 1 and 2, portfolio 12 comprises a bi-fold portfolio 12 having two panels 14 and 16. However, it should be understood that portfolio 12 may comprise a greater quantity of panels.

In the embodiment illustrated in FIGS. 1 and 2, panel 16 is configured to enable releasable engagement of a media object 20 thereto. For example, in the embodiment illustrated in FIGS. 1 and 2, media object 20 comprises a paper pad 22. However, it should be understood that other types of media may be used with system 10. Referring to FIG. 1, panel 16 comprises a slot 24 forming an opening for a pocket 26 formed in panel 16 for receiving at least a portion of paper pad 22 therein (e.g., a cardboard backing member 28 of paper pad 22) for releasably securing paper pad 22 to panel 16. However, it should be understood that panel 16 may be otherwise configured to facilitate releasably securing media object(s) 20 thereto (e.g., corresponding to the different types of media objects 20 that may be used with system 10).

In the embodiment illustrated in FIGS. 1 and 2, system 10 comprises an imaging device 30 secured to panel 14 of portfolio 12 for generating a scanned image of media object 20 disposed on panel 16. For example, in the embodiment illustrated in FIG. 1, imaging device 30 comprises a scanning device 32 having a platen 34 forming a scanning area 36 of scanning device 32 such that an optical head 38 of scanning device 32 moves relative to scanning area 36 to generate a scanned image of an object disposed within scanning area 36. Preferably, in some embodiments of the present invention, imaging device 30 is permanently coupled to panel 14. However, it should be understood that, in other embodiments of the present invention, system 10 may be configured to enable releasable engagement of imaging device 30 to panel 14.

In operation, panel 16 is configured to automatically align media object 20 coupled thereto with imaging device 30 to facilitate scanning of media object 20. For example, in operation, panels 14 and 16 are rotatably coupled relative to each other to facilitate movement of panels 14 and 16 relative to each other to facilitate positioning of a surface 40 of panel 16 facing and/or otherwise disposed toward imaging device 30. Thus, in operation, in the embodiment illustrated in FIGS. 1 and 2, slot 24 and/or pocket 26 is positioned on panel 16 to automatically align paper pad 22 with imaging device 30 by disposing paper pad 22 within scanning area 36 of imaging device 30 when panels 14 and 16 are disposed facing or towards each other (e.g., in a scanning position relative to each other). For example, in FIGS. 1 and 2, portfolio 12 is illustrated in an open position such that rotation of panel 16 toward panel 14 in the direction indicated generally by arrows 44 and 46 places and/or otherwise disposes media object 20 within scanning area 36 of imaging device 30 (e.g., disposing media object 20 onto or proximate to platen 34 of scanning device 32). Thus, in operation, media object 20 is used by a user of system 10 to receive image content thereon (e.g., handwritten notes or other types of content). The user then places panel 16 relative to panel 14 in a position such that panel 16 is facing and/or disposed towards panel 14, thereby disposing media object 20 within scanning area 36 of imaging device 30 to facilitate scanning of media object 20. In the embodiment illustrated in FIGS. 1 and 2, imaging device 30 is configured having at least one scanning control mechanism 50 (e.g., for initiating a scanning operation using imaging device 30 and/or selecting a scanning resolution for the scanning operation) disposed on a side panel 52 thereof to facilitate initiating a scanning operation using imaging device 30 when panel 16 is disposed facing or towards panel 14 in a scanning position. However, it should be understood that scanning control mechanism 50 may be otherwise located on imaging device 30. Further, it should be understood that in some embodiments of the present invention, pocket 26 is configured and/or otherwise formed of a transparent material to enable a particular type of media object 20 to be disposed within pocket 26 (e.g., a single sheet of paper) and be exposed to imaging device 30 when panel 16 is disposed facing and/or towards panel 14. It should be understood that pocket 26 may be formed of an opaque material where backing member 28 is slid into pocket 26 while paper of paper pad 22 is disposed exterior to pocket 26 so to be positioned facing panel 14.

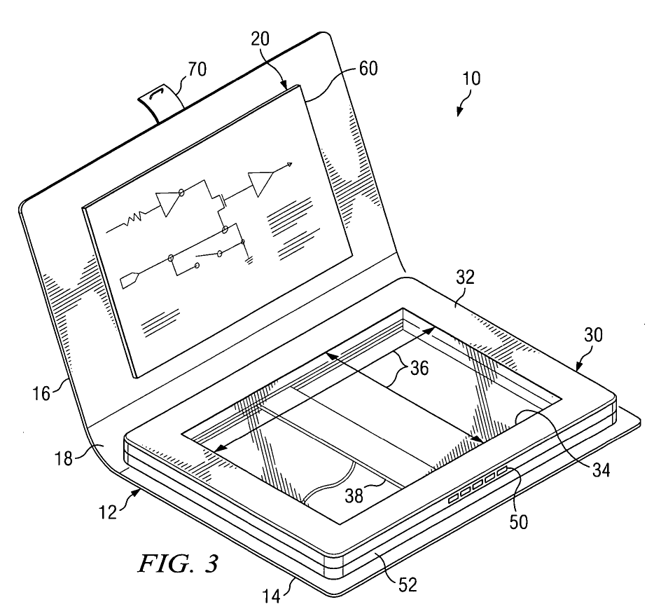

FIG. 3 is a diagram illustrating another embodiment of portable imaging system 10 in accordance with the present invention. In the embodiment illustrated in FIG. 3, media object 20 comprises a whiteboard 60 coupled to panel 16. In some embodiments of the present invention, whiteboard 60 is permanently coupled to panel 16. However, in other embodiments of the present invention, panel 16 and/or whiteboard 60 are configured to be releasably engageable. In operation, image content may be written onto whiteboard 60 by a user of system 10 and panel 16 may then be placed in a position facing or towards panel 14 to facilitate scanning of the image content on whiteboard 60 using imaging device 30. Thus, in operation, whiteboard 60 is located and/or positioned on panel 16 such that whiteboard 60 is automatically aligned with scanning area 36 of imaging device 30 when panel 16 is disposed facing or towards panel 14, thereby facilitating scanning of content written onto whiteboard 60 by imaging device 30.

In the embodiments illustrated in FIGS. 1-3, system 10 comprises a strap element 70 for releasably securing panel 16 in a closed position relative to panel 14, thereby protecting imaging device 30 (e.g., platen 34) during transportation of imaging system 10. However, it should be understood that a variety of different types of clasps, straps, or closure elements may be used for releasably securing panel 16 in a closed position relative to panel 14.

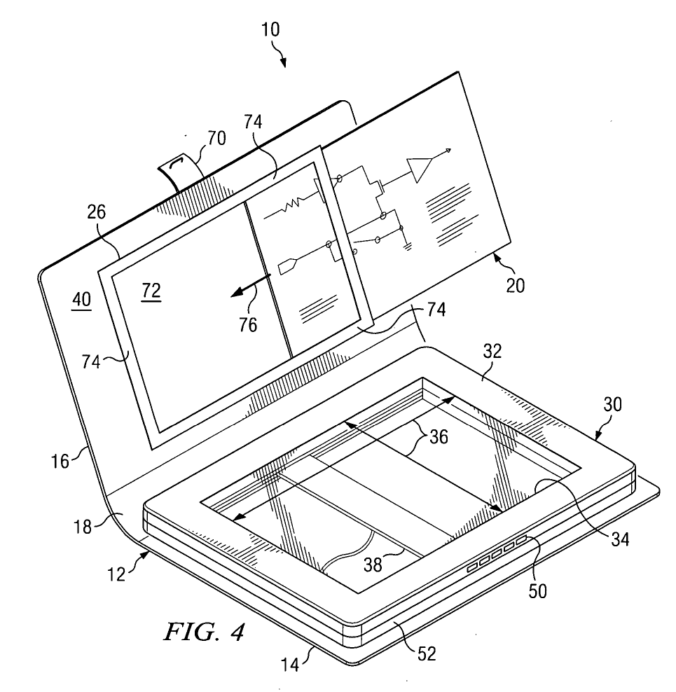

FIG. 4 is a diagram illustrating another embodiment of imaging system 10 in accordance with the present invention. In the embodiment illustrated in FIG. 4, pocket 26 comprises a window 72 having a border 74 extending about a periphery thereof to facilitate exposing at least a portion of media object 20 disposed within pocket 26 to imaging device 30. Thus, in operation, media object 20 is insertable into pocket 26 in the direction indicated by 76. Pocket 26 automatically aligns media object 20 with imaging device 30 upon positioning of panel 16 facing or towards panel 14 to facilitate scanning of media object 20. In the embodiment illustrated in FIG. 4, window 72 comprises an open window 72 to facilitate media object 20 inserted into pocket 26 being disposed directly against platen 34 of imaging device 30 when surface 40 of panel 16 is disposed facing or towards imaging device 30 (e.g., in a scanning position relative to panel 14). In some embodiments of the present invention, border 74 is configured and/or otherwise formed from a transparent material. However, it should be understood that border 74 of pocket 26 may be otherwise configured.

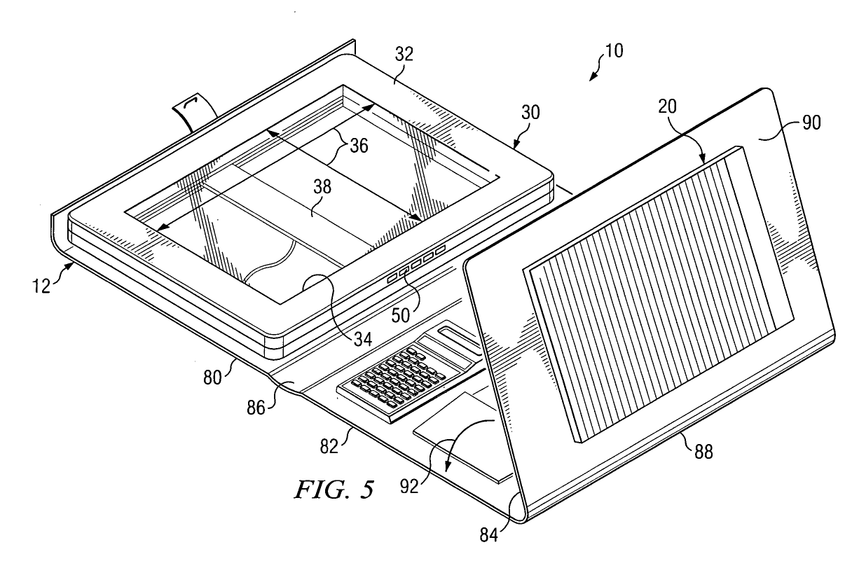

FIG. 5 is a diagram illustrating another embodiment of imaging system 10 in accordance with the present invention. In the embodiment illustrated in FIG. 5, portfolio 12 comprises a tri-panel portfolio 12 having panels 80, 82 and 84 movably coupled to each other. For example, in the embodiment illustrated in FIG. 5, a flexible binder portion 86 movably couples panels 80 and 82 together, and a flexible binder portion 88 movably couples panels 82 and 84 together, such that binder portions 86 and 88 enable respective rotatable movement of panels 80, 82 and 84 relative to each other. However, it should be understood that panels 80, 82 and 84 may be otherwise coupled together.

In the embodiment illustrated in FIG. 5, imaging device 30 is coupled to panel 80, and media object 20 is coupled to a surface 90 of panel 84. As described above, portfolio 12 is configured such that folding and/or moving one or more panels of portfolio 12 relative to each other aligns and/or otherwise places media object 20 in a scanning position relative to imagine device 30. For example, in the embodiment illustrated in FIG. 5, panel 84 is foldable and/or otherwise rotatable relative to panel 82 in the direction indicated by 92. Panel 80 and panels 82/84 are movable relative to each other (e.g., about binder portion 86) to facilitate placement and/or positioning of media object 20 on surface 90 of panel 84 facing or disposed towards imaging device 30 in a scanning position. Thus, it should be understood that system 10 may be formed in a variety of different configurations.

Thus, embodiments of the present invention enable a convenient and portable imaging system 10 for scanning media object(s) 20 (e.g., such as image content written onto media object(s) 20). Further, embodiments of the present invention may be formed using a variety of different multi-panel configurations (e.g., bi-panel, tri-panel, etc.). Additionally, embodiments of the present invention facilitate convenient and protected portability of an imaging device by using a foldable portfolio (e.g., panels of the portfolio protect the imaging device during transport thereof).

What is claimed is:

1. A portable imaging system, comprising:
a portfolio having at least two panels foldably coupled to each other, at least one of the at least two panels adapted for releasable engagement of a media object thereto; and
an imaging device coupled to another of the at least two panels, the at least one panel configured to automatically align the media object with the imaging device when the at least one panel is disposed in a position facing the another panel to facilitate scanning of the media object by the imaging device.

2. The system of claim 1, wherein the media object comprise a paper pad.

3. The system of claim 1, wherein the at least one panel comprises a slot for releasably engaging a paper pad thereto.

4. The system of claim 1, wherein the media object comprises a whiteboard.

5. The system of claim 1, wherein the portfolio comprises a bi-fold portfolio.

6. The system of claim 1, wherein the at least one panel is disposed adjacent the another panel.

7. The system of claim 1, wherein the imaging device is configured to enable initiation of a scan of the media object.

8. The system of claim 1, wherein the at least one panel is adapted to automatically align the media object within a scanning area of the imaging device.

9. The system of claim 1, wherein the at least one panel is adapted to automatically dispose the media object against a platen of the imaging device upon disposing the at least one panel facing the other panel.

10. The system of claim 1, wherein the portfolio is adapted to enable releasable engagement of the at least one panel to the other panel.

11. The system of claim 1, wherein the imaging device comprises at least one scanning control mechanism disposed on a side panel thereof.

12. The system of claim 1, wherein the imaging device comprises at least one scanning control mechanism disposed in a user-accessible location when the at least one panel is disposed in the position facing the another panel.

13. The system of claim 1, wherein the at least one panel and the another panel are formed integrally with each other.

14. The system of claim 1, wherein the at least one panel comprises a window for exposing at least a portion of the media object to the imaging device.

15. The system of claim 1, wherein the at least one panel comprises a pocket for receiving the media object.

16. The system of claim 1, wherein the at least one panel comprises a transparent pocket for receiving the media object.

17. A portable imaging system, comprising:
means disposed on a first panel of a foldable portfolio for generating a scanned image of a media object; and
means disposed on a second panel of the foldable portfolio for automatically aligning a media object releasably coupled to the second panel with the means for generating the scanned image when the first panel is disposed in a position facing the second panel to facilitate scanning of the media object by the means for generating the scanned image.

18. The imaging system of claim 17, further comprising means disposed on the means for generating the scanned image and accessible by a user for initiating a scan of the media object when the first panel is in the position facing the second panel.

19. The imaging system of claim 17, further comprising means disposed on the second panel for releasably coupling the media object to the second panel.

20. The imaging system of claim 17, further comprising means for releasably coupling the first panel to the second panel.

21. The imaging system of claim 17, wherein the means for automatically aligning comprises means for automatically disposing the media object within a scanning area of the means for generating the scanned image.

22. A portable imaging system, comprising:
a portfolio having a first panel movably coupled to a second panel;
an imaging device coupled to the second panel, the first panel adapted to automatically position a media object coupled thereto within a scanning area of the imaging device when the first panel is disposed in a position facing the second panel to facilitate scanning of the media object by the imaging device.

23. The system of claim 22, wherein the media object comprise a paper pad.

24. The system of claim 22, wherein the first panel comprises a slot for releasably engaging a paper pad thereto.

25. The system of claim 22, wherein the media object comprises a whiteboard.

26. The system of claim 22, wherein the portfolio comprises a bi-fold portfolio.

27. The system of claim 22, wherein the first panel is disposed adjacent the second panel.

28. The system of claim 22, wherein the imaging device is configured to enable initiation of a scan of the media object.

29. The system of claim 22, wherein the first panel is adapted to automatically dispose the media object against a platen of the imaging device.

30. The system of claim 22, wherein the imaging device comprises at least one scanning control mechanism disposed on a side panel thereof.

31. The system of claim 22, wherein the imaging device comprises at least one scanning control mechanism disposed in a user-accessible location when the first panel is disposed in the position facing the second panel.

32. The system of claim 22, wherein the first panel and the second panel are formed integrally with each other.

33. The system of claim 22, wherein the first and second panels are configured to be releasably secured to each other.

34. The system of claim 22, wherein the first panel comprises a window for exposing at least a portion of the media object to the imaging device.

35. The system of claim 22, wherein the first panel comprises a pocket for receiving the media object.

36. A portable imaging system, comprising:
a portfolio having a first panel movably coupled to a second panel, the second panel having an imaging device coupled thereto, the first panel adapted to receive an image written thereto by a user, the first panel adapted to automatically align the written image with the imaging device when the first panel is disposed in a position facing the second panel to facilitate scanning of the written image by the imaging device.

37. The system of claim 36, wherein the first panel comprises a paper pad coupled thereto for receiving the written image.

38. The system of claim 36, wherein the first panel comprises a whiteboard coupled thereto for receiving the written image.

39. The system of claim 36, wherein the imaging device is configured to enable initiation of a scan of the written image.

40. The system of claim 36, wherein the first panel is adapted to automatically dispose the written image against a platen of the imaging device when the first panel is disposed in the position facing the second panel.

41. The system of claim 36, wherein the first panel is adapted to automatically dispose the written image within a scanning area of the imaging device when the first panel is disposed in the position facing the second panel.

42. The system of claim 36, wherein the first and second panels are configured to be releasably secured to each other.

43. The system of claim 36, wherein the imaging device comprises at least one scanning control mechanism disposed on a side panel thereof.

44. The system of claim 36, wherein the imaging device comprises at least one scanning control mechanism disposed in a user-accessible location when the first panel is disposed in the position facing the second panel.
